(19) United States
(12) Patent Application Publication
(10) Pub. No.: US 2009/0000358 A1
(43) Pub. Date: Jan. 1, 2009

(54) Method of Analysis Using Chromatographic Pre-Separation

(75) Inventor: Hendrik Kerkdijk, Amsterdam (NL)

Correspondence Address: MORRISON & FOERSTER LLP, 12531 HIGH BLUFF DRIVE, SUITE 100, SAN DIEGO, CA, 92130-2040, US

(73) Assignee: NEDERLANDSE ORGANISATIE VOOR TOEGEPASTNATUURWETEN, Delft (NL)

(21) Appl. No.: 11/579,476

(22) PCT Filed: May 4, 2004
(86) PCT No.: PCT/NL2004/00301

§ 371 Date: Aug. 5, 2008

(51) Int. Cl. G01N 30/84

(52) U.S. Cl. 73/61.55

(57) ABSTRACT

The present invention relates to a method for analysing a fluid, comprising applying the fluid to a pre-separation module and subjecting the fluid to a chromatographic pre-separation, taking a sample from said zone; and subjecting said sample to an analytical separation. The invention further relates to an apparatus for analysing a fluid, suitable for carrying out a method according to the invention.

The invention relates to a method for analysing a fluid making use of an online coupling between a chromatographic pre-separation and subsequently an analytical separation.

Methods which combine the on-line use of different separation techniques are commonly known for many years. Well-known are various combinations of liquid chromatography (as pre-separation), followed by analysis of a fraction of eluent from the liquid chromatograph by GC. Typically, a small volume of a fluid is first injected into a pre-separation chromatographic column, such as a gel permeation chromatography (GPC) column or a solid phase extraction (SPE) column, wherein a component of interest (i.e. a component of which the presence is to be qualitatively and/or quantitatively analysed) is separated from one or more other components that may disturb the analysis by elution chromatography. The conditions are chosen such that an essentially complete separation of the component of interest from the disturbing component(s) is effected. The component of interest thus migrates through the column in a zone separate from the disturbing components.

Due to the phenomenon generally known as band broadening (as a result of a combination of eddy diffusion, longitudinal diffusion and mass transfer effects) a concentration gradient exist over the zone in the flow direction, typically visualised by the Gaussian shape component peaks in a chromatogram normally have. For an accurate analysis it is required that the zone with the component of interest is integrally injected into the analytical separation system.

A drawback thereof is the need for an analytical system that allows for large volume injections. Large volume injections tend to complicate GC analysis. This is especially true for volumes higher than about 50 to 100 μl. For instance, for gas chromatography (GC) as an analytical separation system, the use of large volume injection systems (LVI) is needed to allow integral injection of the zone with the component of interest. Such systems are more expensive, more difficult to optimise and lees robust than the basic direct GC injection systems. Further, LVI tends to be less suitable for the analysis of samples comprising high contents of lowly volatile solvents.

It is an object of the present invention to provide a method for analysing a fluid that may serve as an alternative for known methods of analysis.

In particular, it is an object of the invention to provide a robust method that allows the accurate analysis of a fluid in an on-line method combining a pre-separation and an analytical separation.

It is further an object of the invention to provide a novel apparatus, suitable for carrying out a method according to the invention.

It has now been found possible to make use of a specific chromatographic technique in combination with an analytical separation.

Accordingly, the present invention relates to a method for analysing a fluid, in particular an on-line method, comprising

applying the fluid to a pre-separation module and subjecting the fluid to a chromatographic pre-separation (in a pre-separation chamber of said module), wherein the fluid is applied to the module in an amount sufficient to create a volume overload (of the pre-separation chamber of said module)

taking a sample from the pre-separated fluid, said sample containing a component of interest (i.e. a component that is to be analysed); and

subjecting said sample to an analytical separation;

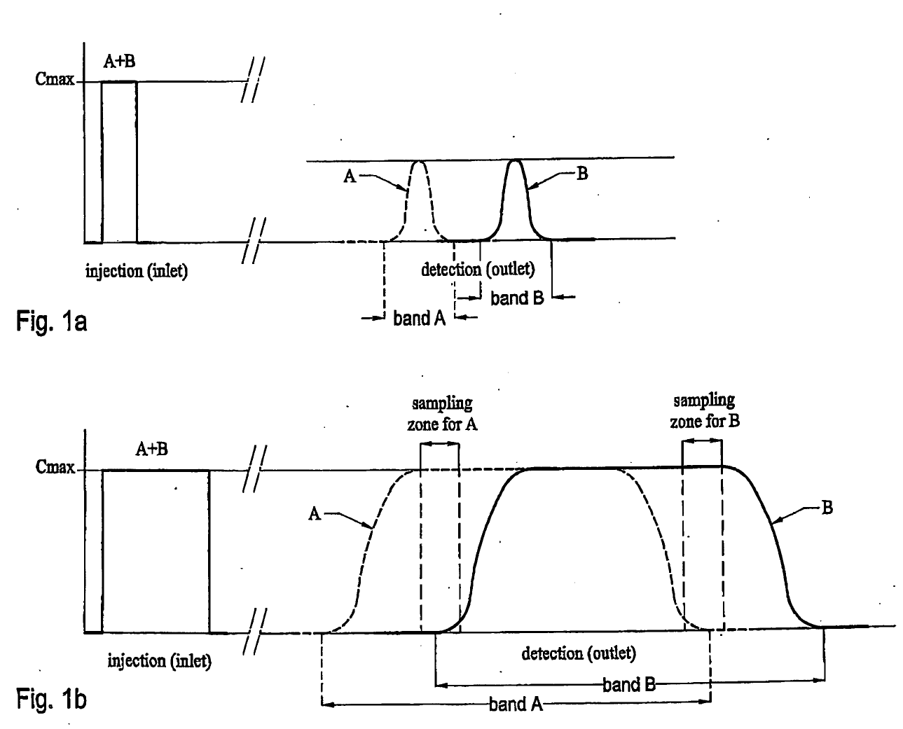

As is generally known, under volume-overload conditions, the applied volume of fluid is so large that the band in which a component present in a fluid that is applied to a chromatographic system elutes from the pre-separation chamber (such as the column) is so wide that in a central part of the band the concentration of the component is essentially constant (in the flow direction). This can be visualised in a chromatogram as a peak with a flattened top (see FIG. 1). The component of interest is at least partially separated from a possibly disturbing component The sample is generally taken from a zone in the band in the eluent of the—pre-separation module wherein the concentration is essentially horizontal and wherein the concentration of the disturbing component is reduced compared to the concentration of the component of interest.

More in particular, the invention relates to a method, preferably an on-line method, for analysing a fluid, comprising

applying the fluid to a pre-separation module and subjecting the fluid to a chromatographic pre-separation (in a pre-separation chamber of said module), wherein the fluid is applied to the module in an amount sufficient to create a zone (moving through the chamber) during the pre-separation, in which zone (as it nears the end of the pre-separation chamber)

(i) the concentration gradient in the flow direction of a component of interest is essentially horizontal, and
(ii) the ratio of the concentration of the component of interest to the concentration of a potentially analysis-disturbing component is increased compared to the ratio in the fluid as applied to the module, preferably at least about four times increased, more preferably at least about 10 times increased, even more preferably at least about BO times increased;

taking a sample from said zone; and

subjecting said sample to an analytical separation;

In a method according to the invention an “essentially horizontal concentration gradient” means that for a discrete period of time (i.e. a measurable period) during the pre-separation, the concentration of the component of interest remains essentially constant and larger than zero at a specific point (in particular at the outlet) in the pre-separation module.

Usually, the actual concentration of the component of interest at the end of the pre-separation module is essentially the same as the concentration of the component of interest in the fluid as applied to the pre-separation module. In particular, an essentially constant concentration is usually about the same as the concentration of the component in the fluid as applied.

An “essentially horizontal gradient” as used herein can be visualised by taking a chromatogram of the pre-separation step (e.g. by means generally known in the art such as by photospectrometric detection, light scattering detection or refractometric detection). An essentially horizontal gradient exists when the zone defined above gives rise to a peak with a flattened top, instead of a Gaussian peak, or more in particular when the zone gives rise to a plug with a trapezoid shape (wherein the front and the back end may have a curves appearance as in the front-half respectively back-half of a Gaussian peak.).

It has been found that a method according to the invention allows an accurate quantitative analysis of a component of interest with acceptable recoveries and reproducibility.

Further, it has been found that a method according to the invention is efficient, with respect to time and/or system costs. In comparison to known on-line methodology it has been found that it can be performed on relatively simple and/or low-cost instrumentation. Further it has been found that an on-line method according to the invention is in particular considerably faster than comparable off-line methodology.

Further, it has been found that a method according to the invention extends the application range, compared to known on-line methodology.

Further, it has been found that a method according to the invention is more flexible, in terms of variability in injection volumes, compared to known on-line methodology.

Further, it has been found that a method according to the invention is more robust and less dependent on a stable performance of the pre-separation procedure of known on-line methodology.

Further, it has been found that a method according to the invention facilitates the method development process, compared to known on-line methodology

FIG. 1 shows schematically a conventional elution chromatography pattern, resulting in complete separation of two components into to Gaussian peaks and a chromatography pattern exemplifying a pre-separation in a method according to the invention

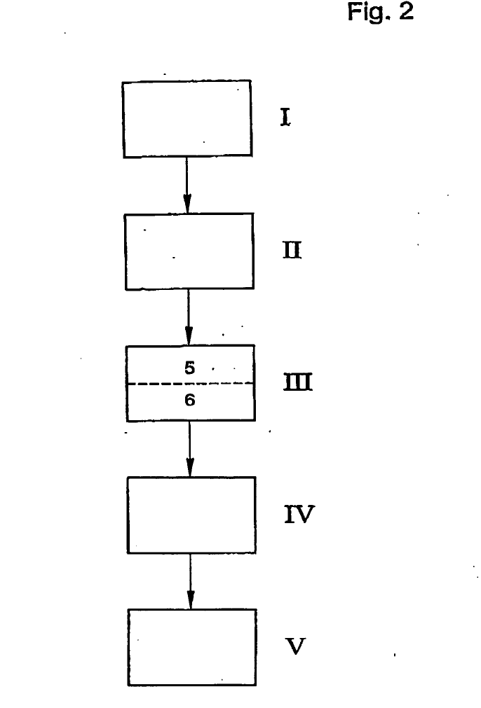

FIG. 2 shows a block diagram showing a set-up of an apparatus for carrying out a method according to the invention.

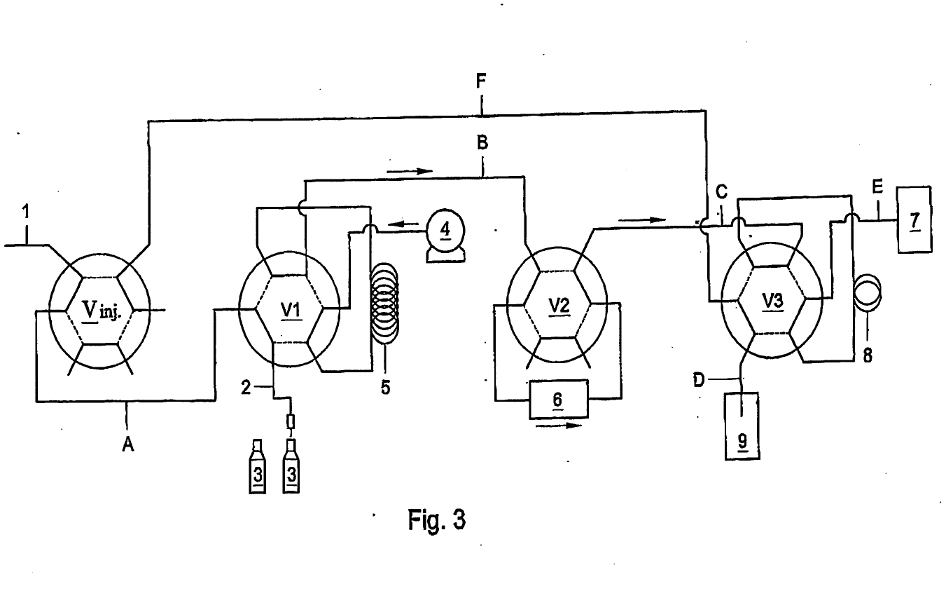

FIG. 3 shows a system suitable for carrying out a method according to the invention, in particular a method wherein use is made of solid phase extraction as pre-separation.

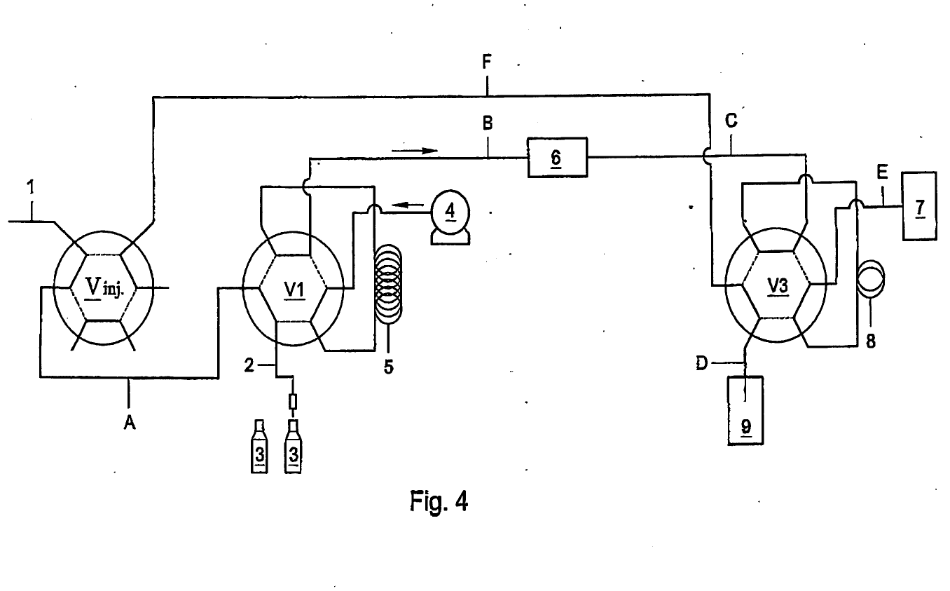

FIG. 4 shows a system suitable for carrying out a method according to the invention, in particular a method wherein use is made of size exclusion chromatography (SEC) as pre-separation.

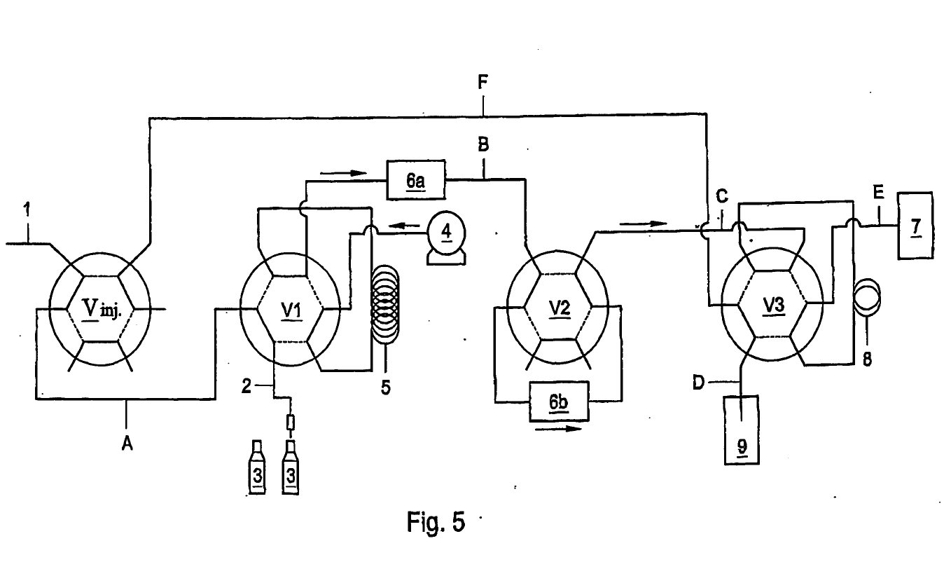

FIG. 5 shows a system suitable for carrying out a method according to the invention, in particular a method wherein use is made SEC and solid phase extraction as pre-separation.

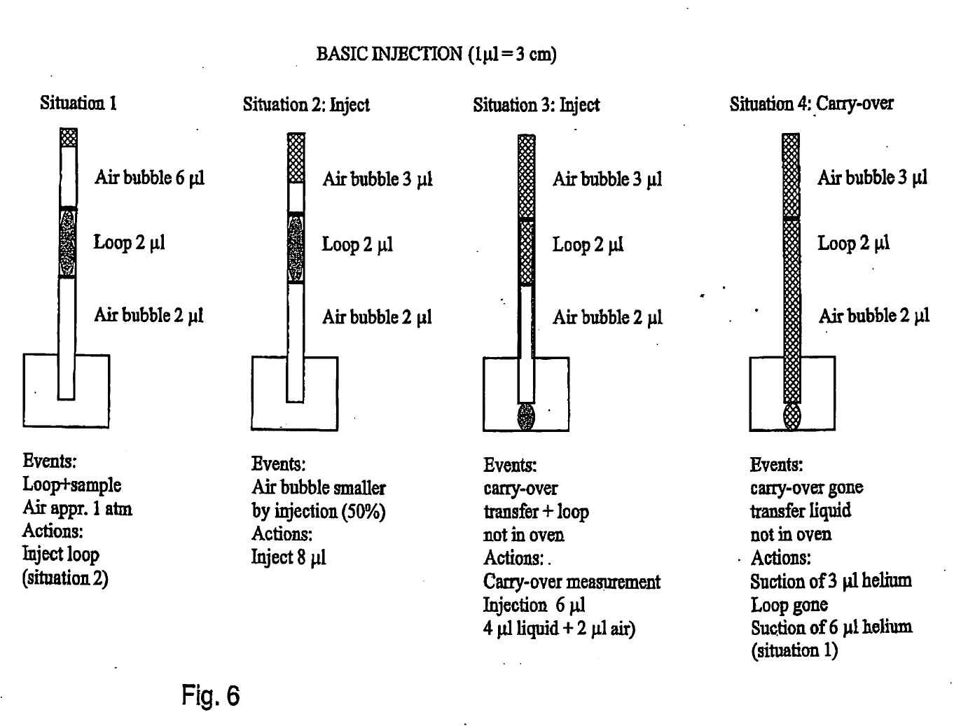

FIG. 6 schematically shows in chronological order the various steps of a sample transfer from the sampling module to the analytical separation module.

FIG. 1 schematically shows the concentration for two components in a fluid at the inlet of the column (left hand side) and the chromatogram (taken at the outlet). The top graph shows a conventional situation, with full resolution of the two components and Gaussian peaks, whereas the bottom graph shows a chromatogram from a pre-separation in accordance with the invention. In FIG. 1, sampling zones A and B indicate highly preferred zones to take the sample from (depending upon whether A or B is the component of interest, or both are), because in these zones A respectively B are completely separated from each other and the concentration gradient is essentially flat.

As shown in FIG. 1, the application of an amount sufficient to create the zone, results in a concentration profile (at the end of the pre-separation module) of a component with a flattened top and curved front and end parts. The front and end parts can generally suitably be curve-fitted with a Gaussian function, whereas the flattened top can generally suitably be curve-fitted with a linear function; this in contrast to conventional pre-separation technique wherein the concentration profile shows a full Gaussian profile.

It will be understood by the skilled person that minor fluctuations in the concentration may occur in relation to terms like “essentially horizontal”, “essentially the same”, “essentially constant”. Such fluctuations may be due to system limitations, detector inaccuracy, difficulty of the sample and the like. The skilled person will understand these terms based upon common general knowledge and the information disclosed herein.

In a preferred embodiment, a concentration is considered constant if it generally fluctuates within not more than 20%±the average value in the zone, depending upon the nature of the fluid. In particular for relatively clean fluids, it has generally been possible to realise much smaller fluctuations, in particular of up about 5%±the average value in the zone.

Further, it is observed that, usually, an essentially constant concentration is about the same as the concentration of the component in the fluid as applied. Preferably, the concentration in the zone is at least 80%, more preferably at least about 95% of the concentration in the fluid as applied. The latter holds in particular true when an isocratic mobile phase is used as pre-separation eluent and that the sample material from the fluid is dissolved in the pre-separation solvent or in a solvent of identical mobile phase strength.

As schematically shown in FIG. 2, in a method according to the invention, some fluid may be taken from a container containing the fluid (I), e.g. a vial in an autosampler, by an application device (II), for instance a syringe injector. The fluid is then applied to the pre-separation module (III). Although the fluid may be applied directly to pre-separation chamber 6 of the module III, it usually is applied via an injection loop 5 or the like. A sample is taken at the sampling module (IV) placed downstream, of the pre-separation module III. Next the sample is applied to the analytical separation module (V).

The exact method conditions (such as eluents, choice of pre-separation module and analytical separation module, etc) depend on the application. Generally the conditions in the pre-separation are chosen such that the component of interest would pass at a good resolution, preferably full resolution (R>1), from interfering substances through the pre-separation module under conventional elution chromatography conditions. The skilled person will know how to chose the conditions based upon common general knowledge and the information disclosed herein.

The pre-separation module may very suitably be selected from modules for liquid chromatography. The pre-separation module comprises a pre-separation chamber and usually a unit to which the application device can apply the fluid and from which the fluid can be applied to the pre-separation chamber, such as an injection loop, connected to the pre-separation chamber.

The separation chamber can be any channel through which the fluid is passed and at least part of the component of interest is separated from the potentially disturbing components), when in use. The component may migrate in front of the potentially disturbing component (as shown in FIG. 1, in case component B is the component of interest) or thereafter (component A as component of interest). In principle, it is also possible that the component of interest migrates in between disturbing components.

A typical example of a pre-separation chamber is a liquid chromatography column, although in principle the chamber may also have another shape (e.g. flat channel, planar etc). In principle another form of chromatography may be employed, in particular GC.

Preferably, the pre-separation chamber comprises at least one material selected from the group consisting of SBC materials (in particular gel permeation chromatography (GPC) materials), solid phase extraction materials (for example graphitised carbon, aminopropyl, SiOH, Al(OH)s), gel sieving chromatography materials, reversed phase (liquid) chromatography, normal phase (liquid) chromatography materials, ion exchange chromatography materials and liquid-solid chromatography (adsorption chromatography) materials and hydrophobic interaction chromatography materials.

Pre-separation with SPE has been found particularly suitable for removal of fatty acids and sugars by anion exchange sorbents, chlorophyll/pigments by graphitised carbon, removal of interfering substances by SiOH and/or Al(OH)s sorbents and removal of amines by means of cation exchange sorbents.

Pre-separation with SEC, such as GPC, has been found particular suitable because/for removal of large interfering substances, in particular, natural and synthetic oils (tri-esters), polymers, carbohydrates or steroids from smaller components of interest. Alternatively it might be used to pre-separate smaller potentially disturbing molecules, in particular salts, from larger molecules of interest.

Pre-separation with GPC and SPE has been found particular suitable for a combined removal with these complementary techniques, in particular a removal of natural esters (such as tri-esters of animal or plant origin) by GPC and (subsequently) the removal of the remaining fatty acids by means of a anion-exchange resin and/or pre-separation of chlorophyll or other pigments by graphitised carbon.

Other applications include the clean-up of dioxins from fatty matrices by means of a combination of GPC (fat removal) and graphitised carbon (such as separation of planar aromatics from other aromatics).

In a preferred method according to the invention use is made of isocratic liquid chromatography. It has been found that isocratic chromatography is particularly suitable to realise a horizontal concentration gradient at the same concentration level as applied.

Alternatively semi-isocratic conditions, i.e. a step gradient, may be used. In principle a step gradient can be used to create a horizontal concentration gradient at an increased level, i.e. above the applied level in the fluid (pre-concentration), or a decreased level. An increased concentration level may improve the detection limit which can be obtained. The skilled person will understand this and knows how to choose the proper chromatographic conditions and eluents.

The application of the fluid to the pre-separation module may be performed in a manner known in the art, depending upon the nature of the pre-separation module.

The skilled person will know how to choose a suitable volume of the fluid applied to the pre-separation module, based upon the specific application, in particular with respect to the nature of the fluid, the system specifications and the like.

Typically, the applied volume is larger than in a comparable conventional method wherein use is made of on-line pre-separation by elution chromatography.

In principle, it is possible to continuously apply fluid to the pre-separation module throughout the pre-separation. For practical reasons, it is preferred to apply the fluid in a finite amount, i.e. the application of the fluid to be analysed is stopped after a horizontal concentration gradient and a satisfactory removal of disturbing components in the highly preferred sampling zones A or B has been obtained (see FIG. 1b).

In a preferred method of the invention, the volume of the fluid applied to the pre-separation module is at least about 1%, more preferably at least about 3%, even more preferably at least about 10%. The upper limit is particularly critical. In practice, the skilled person will be able to choose a practical volume, depending upon the pre-separation technique.

With respect to the application of the fluid to the pre-separation module it has further been found that an improved length of the zone with a horizontal gradient of the component of interest and a increased ratio of the component to the potentially disturbing components) is achieved when use is made of an injection loop for applying the fluid to the separation chamber of the pre-separation module to which the fluid is initially applied and thereafter only a part of the fluid in the injection loop is applied to the separation chamber. Preferably only up to about 90%, more preferably up to about 75% of the volume is applied to the separation chamber. The lower limit is not particular critical. For practical reasons, at least about 50% of the loop is preferably injected.

The fluid is usually passed through the chamber in a manner known for the specific pre-separation chamber. For instance in case of column LC is will be flown through by an eluent.

The fluid is typically a sample of a material which may be dissolved in eluent or another solvent.

It has been found that it is advantageous with respect to creating a horizontal concentration gradient to dissolve a sample of a material to be analysed in an eluting solvent (wherein sample of the material and solvent form the fluid to be analysed). Thus in a preferred method according to the invention, the fluid is a material dissolved in a solvent of which the composition is essentially the same as the eluent used in the chromatographic pre separation and which forms together with this eluent, isocratic mobile phase conditions.

An eluting solvent is a solvent that allows elation of the component of interest in a reasonable time/volume from the pre-separation chamber. Preferably the elution volume is chosen in such a way that the capacity factor lies between 0 and 100, more preferably between 0 and 10. The skilled person will understand what a reasonable time is for a specific application.

Preferably the composition of the pre-separation chamber eluent is about the same as the eluting solvent in which the sample material from the fluid is dissolved. Because of its relatively large volume the latter solvent may become an integral part of the pre-separation chamber eluent and both solvents combined form the preferred isocratic mobile phase conditions during the pre-separation chromatographic run in such an embodiment.

The introduced volume of this fluid in the pre-separation chamber is preferably so large that the dissolution solvent in the eluent becomes the mobile phase of the pre-separation chamber during a considerable part of the pre-separation chromatographic run.

Alternatively, eluent and solvent for a material to be analysed may be different. For instance, for achieving a concentrating effect of a component of interest one may choose the solvent strength of the eluent higher than the solvent strength of the eluent in which the sample material from the fluid is dissolved.

The skilled person will know how to choose such conditions based upon the nature of the component of interest, by choosing a suitable eluent and/or pre-separation material.

Usually a sample is taken from the end of the pre-separation module (in particular at the end of the LC-column). The sampling may very suitably be done with a sampling module coupled to the end of the pre-separation. Such sampling module may suitably comprise an injection loop (suitable for injection of the sample in the analytical separation module) and a detector for monitoring when the component of interest passes through the injection loop.

The identification of a suitable sample (namely of the zone wherein the concentration of the component of interest is increased compared to the potentially disturbing component(s)) may be empirically determined during method development after which the method can be used routinely by preset parameters or can be determined automatically during the pre-separation. Identification of the sample may very suitably be carried out by any non-destructive detector or any destructive detector, suitable for on-line coupling to a LC-system. The detector may be non-selective or selective. Particularly suitable are photospectrometric detectors, including diode array detectors, dual-wavelength spectrometers and (fast) scanning spectrophotometers Light Scattering Detectors (LSD) and Refractive Index (RI) detectors. Selective detectors such as MS detectors are also very suitable.

In practice, only a part of the component of interest, present in the fluid applied to the pre-separation module, is applied to the analytical separation module. In particular, only the component of interest in so far as present in the zone as defined above is injected. Usually, less than about 50% of the initially applied component of interest is applied to the analytical separation module. Particularly good results have been achieved with a method wherein up to 0.001-10% of the pre-separation volume is applied or more preferably 0.01%-1% is applied.

The sample from the pre-separation module is applied to the analytical separation module. The application of the sample may be performed in a manner known in the art, depending upon the nature of the separation module.

The analytical separation module may comprise a liquid chromatograph (LC), a gas chromatograph (GO), capillary electrophoresis equipment (CE), or a combination thereof.

In principle, depending upon the application, it is also possible to subject the sample to direct on-line analysis such as by mass spectrometry (which combines separation and detection), after the pre-separation.

In principle, depending upon the application, it is also possible to take a sample from the zone by a fraction collector and then subjecting the sample to further analysis by any suitable detector, after the pre-separation with or without any further separation.

Very good results have been achieved with gas chromatography as the analytical separation technique. In principle, any gas chromatograph can be used, including conventional GC systems and GC systems equipped with a large volume injection device such as a PTV (programmable temperature vaporising) injector. Since, the present invention allows accurate quantitative analysis without integral injection of the component of interest that has been applied, a lower volume may be injected, thereby simplifying introduction into the GC.

Very good results have been achieved when a conventional GC with a low volume injection device is used, such as a GC equipped with a split-less-injection or on-column injection system.

In a preferred method according to the invention, the sample is injected into a GC in a special manner. In such method the sample is sandwiched in the injection loop between gas bubbles (e.g. air bubbles or helium bubbles) when injected, the volume of the bubbles may have the same order of magnitude as the sample volume, and usually larger than the volume of the sample, e.g. about 2-5 times. The gas bubbles are normally preceded by a transport solvent (eluent) which is transported via the application device.

In a preferred method of the invention use is made of carry-over injection in a GC as the analytical separation module. One or multiple carry-over injections are preferably done during the heating of the GC oven, such as at the end of a previous run (i.e. previous analysis), wherein the GC separation chamber (column) is cleaned. An example of an injection routine is given in FIG. 6. The following actions usually occur in chronological order for each analytical run:
situation 1: loop is filled with sample of interest
situation 2: the sample, the preceding gas bubble and a part of the succeeding airbubble are injected into the GC (analytical separation module) by means of the injector (application device) at the start of the analytical GC run.
situation 3: The remainder of the succeeding airbubble and aliquots (one or several) of the transport solvent are injected at the end of the analytical run in order to remove traces of the sample from the connecting tubing between the injection loop (sampling module) and the GC (analytical separation module).
situation 4/1: The excess of transport fluid is withdrawn from the connecting tubing between the GC oven and the sampling module and replaced with gas from the GC until situation 1 is re-reached.

The invention further relates to an apparatus for analysing a fluid, in particular an apparatus suitable for carrying out a method according to any of the preceding claims.

In an embodiment, an apparatus according to the invention, comprises
a chromatographic pre-separation module, usually comprising a pre-separation chamber of which the inlet, when in use, is coupled to a unit to which a fluid can be applied, such as an injection loop;
a sampling module for taking a sample from the outlet of the pre-separation chamber.
an analytical separation module, of which an inlet side is coupled to the outlet side of the sampling module,
an application device (such as a fluid pump combined with a sampling unit for taking a fluid sample) for applying a fluid to be analysed to the pre-separation module and for applying the sample from the sampling module to the analytical separation module; and preferably a
a holder for a fluid reservoir such as an autosampler.

The application, device is usually coupled to the inlet side of the pre-separation module to the injection loop (or analogue thereof) of the pre-separation module and to the inlet side of the analytical separation module via the sampling module, in particular via the injection loop or analogue thereof in the sampling module.

In an embodiment, an apparatus according to the invention comprises
a chromatographic pre-separation module;
an analytical separation module, of which an inlet side is coupled to an outlet side of the pre-separation module,
a sampling module for taking a sample from the outlet of the pre-separation chamber.
an application device for applying a fluid to be analysed to the pre-separation module,
wherein the pre-separation module is equipped with a high-volume injection loop, for applying fluid to the separation chamber of the pre-separation module (when in use), and the sampling module is equipped with a low-volume injection loop for taking a sample eluting from the pre-separation chamber of the pre-separation module and thereafter applying the contents of the loop to the separation chamber of the analytical separation module (when in use) and preferably a
a holder for a fluid reservoir such as an autosampler.

An apparatus according to the invention preferably comprises a high-volume injection loop coupled to the inlet of the pre-separation chamber. The volume of the loop may be determined depending upon the application and the system dimensions. Good results have in particular been achieved with a high-volume loop having a volume in the range of about 1 μl to about 10 ml.

An apparatus according to the invention preferably comprises a low-volume injection loop coupled to the inlet of the pre-separation chamber. The chosen volume depends upon the system specifications and the application the system is intended for. The volume is generally chosen in the range of 0.1 to 500 μl, preferably in the range of 1 to 50 μl.

The internal diameter of the low-volume injection loop is preferably equal to or larger than the internal diameter of the channel coupling the outlet side of the pre-separation module to the low-volume injection loop.

The ratio of the volume of the high-volume injection loop to the volume of the low-volume injection loop is preferably more than 1, more preferably at least 20. Very good results have been achieved with a ratio up to 10,000, although higher ratios may be employed.

The analytical separation module preferably comprises a gas chromatograph, a liquid chromatograph or a capillary electrophoresis unit. The outlet of the separation chamber of the analytical separation module (such as the LC column, the GC column or the CE column) may be coupled to a detector. Any detector may be used suitable for coupling to the particular separation chamber. Particularly preferred is a mass spectrometer. An on-line detector is optional.

FIGS. 3-5 schematically show several preferred embodiments. Based upon these embodiments, the present description and claims, and common general knowledge the skilled person will be able to design modifications to the systems, e.g. by making use of different types of valves, fluid application devices, pre-separation modules and/or analytical separation modules, within the scope of the present invention. These figures in particular relate to apparatus, wherein the analytical separation module comprises a GC, preferably a GC-MS.

FIG. 3 shows and embodiment which has been found particular suitable for solid-phase elution in combination with an analytical separation such as GC.

The shown apparatus (e.g. a syringe based injector system) contains fluid pump 1 (such as a syringe pump) connected to a sampling unit 2 (such as a hollow needle) for taking some fluid from a fluid reservoir 3 e.g. held in an autosampler. The sampling unit and fluid pump 1 (such as a syringe injector), are connected via multi-way valves V1 and Vinj and channel A. In this embodiment, the fluid pump serves as the application device for both the pre-separation module and the analytical separation module, in this embodiment. When fluid is taken from the reservoir 3, injection loop 5, is at least partially filled.

The volume of the injection loop 5 may for instance be chosen in the range of about 10 μl to 10 nod, more preferably 0.5-10 ml.

After taking the fluid from the container 3 into loop 6, the valve V1 is switched to allow pumping of the fluid from loop 5 to channel B, leading to pre-separation chamber 6 via valve V2. This can be effected by pump 4. It is in principle possible to perform such function by pump 1, depending upon the system specifications. The skilled person will know how to change the set-up to allow this.

Pump 4 may very conveniently be a pump for HPLC purposes; usually an isocratic pump suffices to allow pumping of the fluid from the injection loop to the chamber 6 and passing it through the chamber 6, making use of an appropriate eluent.

The outlet of column 6 is connected to valve V3. As shown in Figure via V2 this may be done via channel C.

The coupling via V2 allows the pre-separation column to be switched in and out of the flow path. When the pre-separation column is out of the flow path channel B is in direct connection with channel C. The possibility to switch the column out of the flow path is preferable for increasing the life-time of a column and/allows on-line clean or exchange of the column.

Channel C is connected to a second injection loop 6, via V3. The loop 8, usually has a smaller volume than loop 5; preferably it is in the range of 1-100 μl. Optionally the injection loop is attached to a detector for detecting the component of interest in order to determine the moment at which the system should start applying the sample in loop 8 to the device 9. Preferably, the detector is placed behind the injection loop, e.g. as shown in the FIG. 3 via channel E. The detector may be any flow-through detector suitable for HPLC, for instance a detector as indicated above.

V3 is further connected to a device for the analytical separation 9, such as a GC unit, via channel D. In an apparatus Channel D is preferably made of a material like fused silica, which may provided with an internal coating to minimalise adhesion of the component of interest, in particular in case device 9 is a GC.

During pre-separation, the eluent (and pre-separated fluid) pass through the injection loop from channel C and—when present—to the detector via channel E, until the loop 8 is filled with a zone comprising the component of interest. Valve V3 may then be switched to allow application of the contents of the sample loop 8 into the analytical separation device 9.

In a preferred embodiment (as shown in FIG. 3) the fluid pump 1 is also connected via Vinj and channel F to V3 to allow taking the sample out of the loop 8 and thereafter to apply it to device 9.

The skilled person will know how to carry amendments to the shown design, based upon specific system requirements without undue burden.

Pre-separation with SPE has been found particularly suitable for removal of fatty acids and sugars by anion exchange sorbents, chlorophyll/pigments by graphitised carbon, removal of several interfering substances by SiOH and/or Al(OH)s sorbents and removal of amines by means of cation exchange sorbents.

FIG. 4 shows an alternative embodiment. In this embodiment the pre-separation chamber is directly coupled to channels B and C, without using a valve V2. An apparatus comprising a set-up as shown in FIG. 4 has been found particularly suitable with one or more SEC columns, such as GPC columns, as pre-separation chamber 6. Alternatively, a normal phase chromatography may be used with the configuration in FIG. 4.

A system as shown ha FIG. 4 is in particular suitable for an application wherein component of interest and potentially contaminating component can be separated based upon their difference in size (in particular molecular weight). Very good results have been achieved in the separation of polymers from polymer additives, components of interest such as pesticides, hormones, (veterinary) drugs, mycotoxins, biocides, environmental contaminants (such as (PCBs, PAHs, Dioxins, flame retardants, endocrine disrupters, etc.) from fatty matrices (such as fatty acids, fatty acid glycerides, mineral oil compositions), protein removal, etc.

FIG. 5 is basically a combination of FIGS. 2 and 3.

A particular advantage of this set-up is that it allows switching of the pre-separation chamber(s) 6b to be switched out of the flow-path while potentially disturbing components are leaving the pre-separation chamber(s) 6a. It may than suitably switch into the flow-path of the eluent from the pre-separation chamber(s) 6a when the component of interest elutes from the pre-separation chamber(s) 6a in a highly preferred zone. Thus, the pre-separation chamber 6b is exposed much less to disturbing components which may contaminate the pre-separation chamber. In addition pre-separation chamber 6b is not exposed to irreversible binding disturbances and/or insolubles.

Thus, a single pre-chamber 6b may very suitably be used multiple times. In particular in case of SPE columns this is interesting, as conventionally they are intended for single-use.

This embodiment has been found particularly suitable with one or more SEC columns 6a and one or more SPE columns 6b. In addition to the application areas already mentioned for FIGS. 2 and 3, a system as shown in FIG. 5 has been found particularly suitable for chlorophyll and/or fatty acid removal from fluids (such as juice or an extract) of a complicated plant material, for instance from an avocado. For the removal of chlorophyll and fatty acid from a plant material an apparatus with a pre-separation module comprising a GPC column, a graphitised carbon column and an aminopropyl column has been found particularly suitable.

The invention will now further be illustrated by the following examples:

### EXAMPLE 1

### Pesticide Analysis in Vegetables, Chlorophyll Removal

Vegetables were cut (50 g)

Ethylacetate and sodiumsulfate (100 ml-25 gram) was added.

Mixture was macerated with Ultraturrax, 1 min.

Then it was centrifuged, 6 min at 2500 rpm

An autosampler vial was filled with 10 ml aliquot of clear supernatant

A system configuration as presented in FIG. 3 was used for analysis.

A 1 ml injection loop (application device) was ruled with supernatant

Supernatant was added to a 10*2 mm ID SPE cartridge filled with EnviCarb sorbent (approximately 40 μm particles).

Ethylacetate was used as mobile phase for the preseparation.

A zone was identified for injection with a DAD and 2 μl of highly w preferred zone was injected together with 6 μl of a preceding helium bubble via a 2 μl loop (sampling module) and a cold splitless injector at 70° C. into the GC according to the procedure given in FIG. 6.

The pesticides were separated using a non-polar GC column with an initial temperature of 60° C. and a final temperature of 300° C. and helium as carrier gas at a flowrate of 1.6 ml/min.

Two carry-over injections (similar as injection routine) were performed at the end of the GC run at a temperature of 300° C.

The results were compared with a conventional off-line method, using a conventional solid phase extraction with integral injection of the extracted component of interest, after preconcentration by evaporation. Processing time per sample with the method according to the invention was almost 50% less, whilst maintaining an accurate and well reproducible analysis.

### EXAMPLE 2

### Pesticide Analysis in Oils, Oil Removal

The oil was homogenised

A 12.5% oil solution in cyclohexane/etac (1:1) eluent (fluid) was analysed.

An autosampler vial was filled with 10 ml aliquot of clear supernatant

A system configuration as presented in FIG. 4 was used.

A 7 ml injection loop (application device) was filled with fluid

The supernatant was applied to two serial polymer labs PLgel 5 μm, 5 Å, 7.5*300 mm ID GPC columns.

Cyclohexane/etac (1:1) as mobile phase eluent at a flowrate of 1 ml/min was used. The flowrate was decreased just prior to injection of the preferred zone into the GC to 70 μl/min.

20 μl of highly preferred zone and 42 μl of a preceding helium bubble via a 20 μl loop (sampling module) and a PTV injector at 50° C. into the GC according to the procedure given in FIG. 6 was injected.

The pesticides were analysed using a non-polar GC column with an initial temperature of 90° C. and a final temperature of 300° C. and helium as carrier gas at a flowrate of 1.5 ml/min.

4 carry-over injections (similar as injection routine) were performed at the end of the GC run at a temperature of 300° C.

This method was compared with a conventional off-line GPC clean-up (with integral injection of the component of interest) combined with GC-MS. The labor time was about 4 times faster. The method of the invention showed very good reproducibility (in general less than 2% RSD, less than 1% RSD for many compounds).

1. Method for analyzing a fluid for a component of interest, comprising:
applying the fluid to a pre-separation module and subjecting the fluid to a chromatographic pre-separation, wherein the fluid is applied to the module in an amount sufficient to create a zone during the pre-separation, in which the zone comprises a concentration gradient of the component of interest, wherein the concentration gradient comprises a flow direction of the component of interest which is essentially horizontal and the ratio of the concentration of the component of interest to the concentration of a potentially analysis-disturbing component is increased compared to the ratio in the fluid as applied to the module;
taking a sample from said zone where the concentration of the component of interest is essentially horizontal; and
subjecting said sample to an analytical separation.

2. The method of claim 1, further comprising applying the fluid to the module in an amount sufficient to create a volume overload with respect to a component of interest.

3. The method of claim 1, wherein the pre-separation comprises subjecting the fluid to size exclusion chromatography (SEC), solid phase extraction, gel sieving chromatography, reversed phase chromatography, normal phase chromatography, ion exchange chromatography, liquid-solid chromatography, hydrophobic interaction chromatography or a combination of any of these techniques.

4. The method of claim 1, wherein the pre-separation of the fluid comprises isocratic liquid chromatography, preferably isocratic SEC, isocratic solid phase extraction or a combination thereof.

5. The method of claim 1, wherein the analytical separation comprises subjecting the sample to liquid chromatography (LC), gas chromatography (GC), capillary electrophoresis (CE) or a combination of any of these techniques.

6. The method of claim 1, further comprising pre-separating the fluid by normal phase chromatography, by SEC, by solid phase extraction or by SEC and solid phase extraction, prior to analytically separating the sample by GC.

7. The method of claim 1, wherein only a part of the component of interest, present in the fluid applied to the pre-separation module, is applied to the analytical separation module.

8. The method of claim 1, wherein the fluid is a material dissolved in a solvent of which the composition is essentially the same as the eluent used in the chromatographic pre-separation.

9. The method of claim 1, wherein the fluid is a material dissolved in an eluting solvent of which the composition and solvent strength deviates from the eluent used during the chromatographic pre-separation thereby obtaining increased or decreased horizontal concentration levels of the material of interest compared to the applied level.

10. The method of claim 1, wherein the application of the fluid to the pre-separation module and of the sample to the analytical separation module is performed by a single application device.

11. The method of claim 1, wherein the fluid is applied to the pre-separation module via an injection loop.

12. The method of claim 1, wherein the component of interest is selected from the group of, pesticides, polymer additives, biocides, pharmaceutical compounds, environmental contaminants, and natural constituents.

13. The method of claim 1, wherein the fluid is selected from the group consisting of body fluids, fluids from plants, extracts from plant material, extracts from animal material, polymer compositions, extracts of polymer compositions, foodstuffs, extracts of foodstuffs, environmental samples.

14. The method of claim 1, wherein the analytical separation module is a GC and the sample is applied to the GC by at least one carry over injection.

15. An apparatus for analyzing a fluid, comprising:
a chromatographic pre-separation module, comprising a pre-separation chamber of which the inlet, when in use, is coupled to a unit to which a fluid can be applied;
a sampling module for taking a sample from the outlet of the pre-separation chamber, coupled to the outlet of the pre-separation module;
an analytical separation module, of which an inlet side is coupled to an outlet side of the sampling module;
an application device for applying a fluid to be analyzed to the pre-separation module and for applying the sample from the sampling module to the analytical separation module; and
a holder for a fluid reservoir.

16. The apparatus of claim 15, wherein the application device is coupled to the pre-separation module via a high-volume injection loop and to the analytical separation module via a low-volume injection loop.

17. The apparatus of claim 15, wherein the pre-separation module is equipped with a high-volume injection loop.

18. The apparatus of claim 15, wherein the internal diameter of the low-volume injection loop is equal to or larger than the internal diameter of the channel coupling the outlet side of the pre-separation module to the low-volume injection loop.

19. The apparatus of claim 15, wherein the ratio of the volume of the high-volume injection loop to the volume of the low-volume injection loop is more than 1.

20. The apparatus of claim 15, wherein the application device is a syringe injector device.

21. The apparatus of claim 15, wherein, when, in use, the pre-separation module comprises at least one separation chamber selected from size exclusion chromatography (SEC) columns, solid phase extraction columns, gel sieving chromatography columns, reversed phase chromatography columns, normal phase chromatography columns, ion exchange chromatography column, liquid-solid chromatography columns and hydrophobic interaction chromatography columns.

22. The apparatus of claim 15, wherein the pre-separation module comprises a chromatography column, which is coupled to the application device and the analytical separation module via a multi-way valve.

23. The apparatus of claim 21, wherein the pre-separation module comprises at least one other column, placed up-stream of the SPE column.

24. The apparatus of claim 15, wherein the analytical separation module comprises a gas chromatograph, a liquid chromatograph or a capillary electrophoresis unit.

25. The apparatus of claim 23, wherein the gas chromatograph comprises a split-less-injection system, on-column injection system or a large volume injector.

26. (canceled)
